(19) United States
(12) Patent Application Publication
(10) Pub. No.: US 2009/0074491 A1
(43) Pub. Date: Mar. 19, 2009

(54) IMAGE FORMING APPARATUS AND IMAGE FORMING METHOD

(76) Inventor: Hiroshi MOROHOSHI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/207,843

(22) Filed: Sep. 10, 2008

(30) Foreign Application Priority Data
Sep. 18, 2007 (JP) 2007-241419
Mar. 18, 2008 (JP) 2008-069965
Jun. 13, 2008 (JP) 2008-155408

(51) Int. Cl. G03G 15/00

(52) U.S. Cl. 399/388; 399/397

(57) ABSTRACT

An image forming apparatus includes a housing having a planar top surface and a plurality of legs projecting downward from end portions of the housing for supporting the housing on ground. A paper feed unit, an image forming unit, and an output unit are arranged in a substantially horizontal direction inside the housing.

### CROSS-REFERENCE TO RELATED APPLICATIONS

The present application claims priority to and incorporates by reference the entire contents of Japanese priority document 2007-241419 filed in Japan on Sep. 18, 2007, Japanese priority document 2008-69965 filed in Japan on Mar. 18, 2008 and Japanese priority document 2008-155408 filed in Japan on Jun. 13, 2008.

### BACKGROUND OF THE INVENTION

1. Field of the Invention

The present invention relates to an image forming apparatus and an image forming method.

2. Description of the Related Art

A terminal device that generates document data or image data to be printed and a printing device that prints the document data or the image data are generally provided in different casings. A printer or a multi function peripheral (MFPs) is an example of the printing device. A personal computer or a scanner is an example of the terminal device.

For instance, in the technique described in Japanese Patent Application Laid-open No. 2006-228208, a scanner and an MFP are provided in separate casings, and a document is scanned with the scanner to obtain image data and the image data is printed with the MFP.

However, if a terminal device and a printing device are provided in separate casings, they occupy substantial space. For instance, some hotels have single occupancy guest rooms equipped with a personal computer, a printer, and a scanner placed on a table, which makes the already small room more congested and uncomfortable. This has been a problem for providers of these apparatuses. Meanwhile, because these apparatuses are provided in separate casings, operating efficiency and a level of convenience are low. Arranging the multiple apparatuses in a limited space also causes a user to have an impression of being cramped.

### SUMMARY OF THE INVENTION

It is an object of the present invention to at least partially solve the problems in the conventional technology.

According to an aspect of the present invention, there is provided an image forming apparatus that includes a housing having a substantially planar top surface; a plurality of legs projecting downward from the housing for supporting the housing on ground; a paper feed unit that houses a blank paper therein; an image forming unit that performs image forming operation on a blank paper to obtain an image-printed paper; an output unit that receives the image-printed paper from the output unit; and a conveying unit that conveys the blank paper from the paper feed unit to the image forming unit and conveys the image-printed paper from the image forming unit to the output unit. The paper feed unit, the image forming unit, and the output unit are arranged in a substantially horizontal direction inside the housing.

According to another aspect of the present invention, there is provided a method to be performed by an image forming apparatus, the image forming apparatus including a housing having a planar top surface; a plurality of legs projecting downward from end portions of the housing for supporting the housing on ground; a paper feed unit that houses a blank paper therein; an image forming unit that performs image forming operation on a blank paper to obtain an image-printed paper; an output unit that receives the image-printed paper from the output unit; and a conveying unit that conveys the blank paper from the paper feed unit to the image forming unit and conveys the image-printed paper from the image forming unit to the output unit. The paper feed unit, the image forming unit, and the output unit are arranged in a substantially horizontal direction inside the housing. The method includes the conveying unit conveying a blank paper from the paper feed unit to the image forming unit; the image forming unit performing image forming operation on the blank paper to obtain an image-printed paper; and the conveying unit conveying the image-printed paper from the image forming unit to the output unit.

According to still another aspect of the present invention, there is provided an image forming apparatus that includes a paper feed unit that houses a blank paper therein; a scanner unit that scans a surface of a printed material to obtain image data of the surface; an image forming unit that performs image forming operation on a blank paper based on the image data to obtain an image-printed paper; an output unit that receives the image-printed paper from the output unit; a first housing having a planar top surface and housing the paper feed unit; a second housing having a planar top surface and housing the scanner unit and the image forming unit; a third housing having a planar top surface and housing the output unit; a frame detachably supporting the first housing, the second housing, and the third housing; and a plurality of legs projecting downward from end portions of the frame for supporting the frame on ground. The frame supports the first housing, the second housing, and the third housing in a substantially horizontal direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view of an internal configuration of a printer according to a first embodiment of the present invention;

FIG. 2 is a perspective view of an external configuration of the printer;

FIG. 3 is a perspective view of an internal configuration of relevant parts of the printer;

FIG. 4 is a perspective view of internal configuration of relevant parts of the printer;

FIG. 5 depicts an example of a screen displayed on a liquid-crystal touch-panel monitor of the printer shown in FIG. 1;

FIG. 6 depicts another example of the screen displayed on the liquid-crystal touch-panel monitor;

FIG. 7 depicts an example of how the printers according to the first embodiment can be arranged;

FIG. 8 depicts another example of the screen displayed on the liquid-crystal touch-panel monitor of the printer shown in FIG. 1;

FIG. 9 depicts another example of the screen displayed on the liquid-crystal touch-panel monitor and an example of a printout of the screen;

FIG. 10 depicts an authentication card necessary for access to the printer according to the first embodiment;

FIG. 11 depicts an example of a screen displayed on the liquid-crystal touch-panel monitor when access to the printer is permitted;

FIG. 12 depicts how a scanning operation is performed with the printer according to the first embodiment;

FIG. 13 depicts how scanned data is printed with the printer according to the first embodiment;

FIG. 14 depicts how data is downloaded with the printer according to the first embodiment;

FIG. 15 depicts how downloaded data is displayed on the liquid-crystal touch-panel monitor;

FIG. 16 depicts how the data that has been displayed on the monitor is printed;

FIG. 17 depicts how the printer ejects a paper on which the data has been printed;

FIG. 18 is a schematic diagram of an example of a specific application of the printer according to the first embodiment;

FIG. 19 is a front view of a configuration of a multi function peripheral according to a second embodiment of the present invention;

FIG. 20 is a perspective view of the configuration of the multi function peripheral;

FIG. 21 depicts a relation between a main frame and detachable units of the multi function peripheral;

FIG. 22 is a perspective view of a configuration of the main frame shown in FIG. 21;

FIG. 23 is an enlarged side-view of the main frame shown;

FIG. 24 depicts an exemplary horizontal arrangement of the detachable units;

FIG. 25 depicts an exemplary vertical arrangement of the detachable units; and

FIG. 26 depicts an arrangement of component units of a conventional MFP.

### DETAILED DESCRIPTION OF THE PREFERRED EMBODIMENTS

Exemplary embodiments of the present invention are explained in detail below with reference to the accompanying drawings.

A printer 1000, which is a specific example of an image forming apparatus, will be used below to describe an embodiment of the present invention. The printer 1000 has a printing function realized with, for example, a color printer, and an information processing function realized with a personal computer (PC) or the like, housed in one casing. Meanwhile, instead of a simple color printer, a multi function peripheral (MFP), which has functions of a copier, a facsimile, a printer, a scanner, and the like housed in one casing, can be used to realize the printing function.

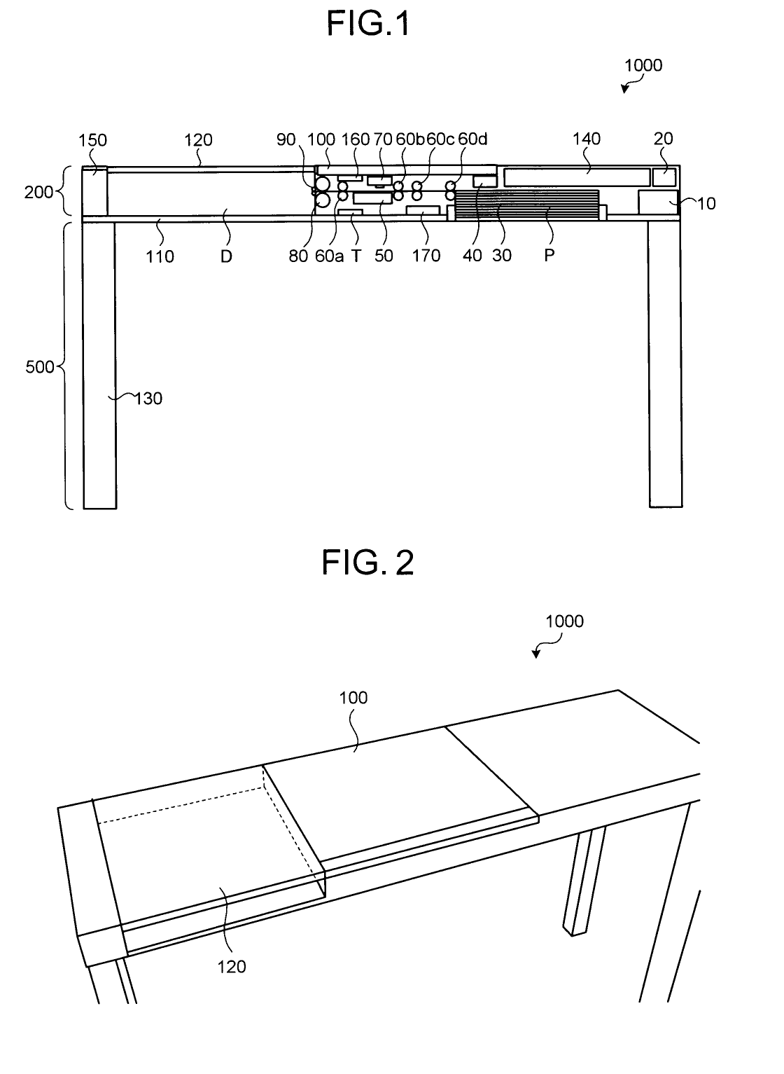

FIG. 1 depicts a physical configuration of the printer 1000 according to a first embodiment of the present invention. The printer 1000 includes a box-shaped housing 200 and a leg unit 500 that horizontally supports the box-shaped housing 200 on the ground. The box-shaped housing 200 houses a power supply unit 10, a storage unit 20, a paper feed unit 30, a communication unit 40, a scanner unit 50, paper-feeding rollers 60a to 60d, a printer unit 70, a paper-output rollers 80, a paper detector 90, a liquid-crystal touch-panel monitor 100, an output-unit bottom plate 110, an output-unit top plate 120, a controller 140, an output-unit illuminating unit 150, a geljet engine 160, an imaging unit 170, an ink tank T, and an output unit D. The leg unit 500 includes four columnar legs 130; however, the number of legs is not limited to four.

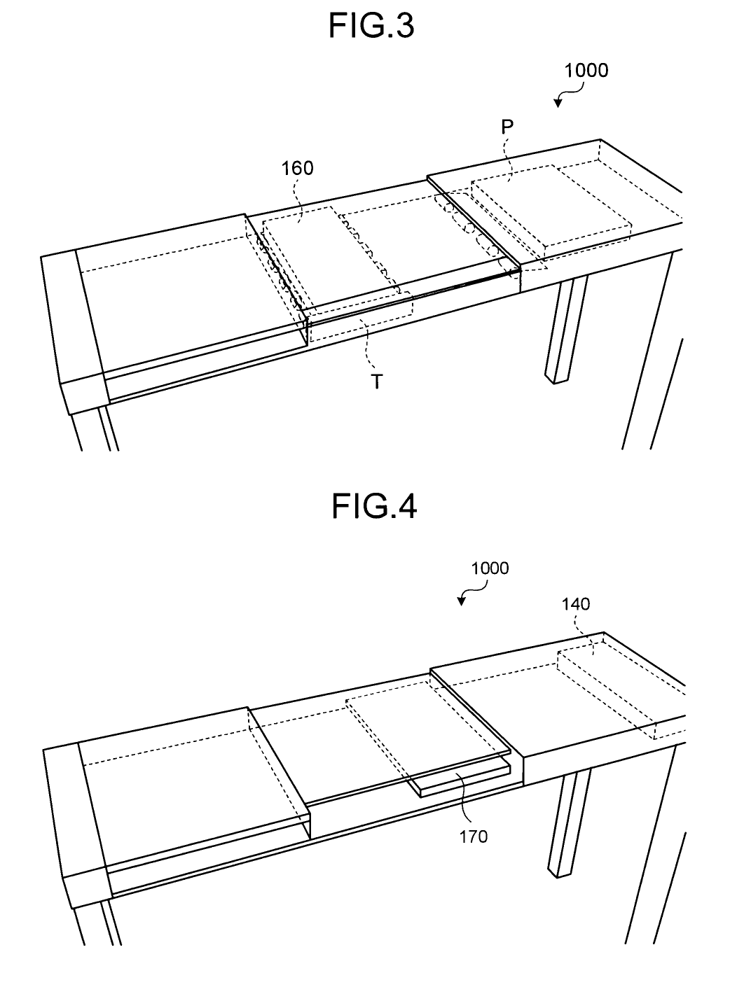

FIG. 2 is an external perspective view of the printer 1000. FIGS. 3 and 4 are perspective views each depicting a portion of an internal structure of the printer 1000. FIGS. 3 and 4 depict positional relationships among the geljet engine 160, the ink tank T, paper P in a ready-for-printing state, the controller 140, and the imaging unit 170 and the like. The paper-feeding rollers 60a to 60d pick-up one blank sheet of the paper P from the paper feed unit 30 and convey it in a substantially horizontal plane toward the paper output rollers 80. The paper output rollers 80 eject the image-printed paper sheet into the output unit D.

Because the paper feed unit 30, the paper-feeding rollers 60a to 60d, the paper output rollers 80, and the output unit D are arranged generally in a substantially horizontal plane, these units can be housed in a thin housing. In other words, the box-shaped housing 200 can be made thinner in a direction perpendicular to the ground thereby allowing efficient use of the space under the box-shaped housing 200. The top surface of the box-shaped housing 200 is a flat surface. Therefore, a user can use the top surface of the box-shaped housing 200 as a desktop.

The power supply unit 10 is a power supply device, such as a direct-current power supply, that supplies electric power to various units of the printer 1000.

The storage unit 20 is a storage medium such as a hard disk drive (HDD) or some other memory. The storage unit 20 stores therein document data, image data obtained by scanning performed by the scanner unit 50, and/or data received by the communication unit 40. The document data can be data created based on data entered by a user onto the liquid-crystal touch-panel monitor 100.

The paper feed unit 30 houses therein a lump of blank printing papers P. When performing printing operation, one blank sheet of the paper P is picked-up by the paper-feeding rollers 60a to 60d from the paper feed unit 30 and conveyed toward the paper output rollers 80.

The communication unit 40 is a communication interface, through which various data including electronic mails (hereinafter, “e-mails”), document data, and image data are exchanged with another PC, a digital camera, or the like external device placed near the printer 1000 or in contact therewith via a wired or wireless communication network or by infrared communication. The communication unit 40 is arranged near the liquid-crystal touch-panel monitor 100. The communication unit 40 detects whether an external device is near or in contact with the printer 1000. When an external device is near or in contact with the printer 1000, the communication unit 40 receives various data from the external device and stores the received data in the storage unit 20.

The scanner unit 50 scans a surface of an original, such as a document or a photograph, placed on the liquid-crystal touch-panel monitor 100. The scanner unit 50 employs an image sensor such as a charge coupled device (CCD) to scan the original. The scanner unit 50 is oriented in such a manner that it's scanning surface faces upward. Moreover, the scanner unit 50 and the printer unit 70 are arranged such that they are parallel to each other and the printer unit 70 is vertically above the scanner unit 50. This configuration allows efficient use of the internal space of the box-shaped housing 200.

The paper-feeding rollers 60a to 60d include plural pairs of rollers. The paper-feeding rollers 60a to 60d pick-up one blank sheet of the paper P from the paper feed unit 30 and convey it toward the paper output rollers 80 via the printer unit 70.

The printer unit 70 is an inkjet printer that uses line scan heads of yellow (Y), magenta (M), cyan (C), and black (K); however, the number and type of the colors is not limited. The printer unit 70 ejects ink drops through the line scan heads of colors each corresponding to color toner images formed by the imaging unit 170 onto the paper P conveyed by the paper-feeding rollers 60a to 60d, thereby forming an image on the paper P.

The paper output rollers 80 deliver the image-printed paper P to the output unit D. As shown in FIG. 1, because the paper feed unit 30, the output unit D, and the imaging unit 170 are arranged in substantially parallel to the ground, paper feeding, printing, paper output, and other operations can be performed efficiently.

The paper detector 90 determines whether the paper P is delivered by the paper output rollers 80. Upon determining that the paper P is delivered by the paper output rollers 80, the paper detector 90 determines that printing has been completed.

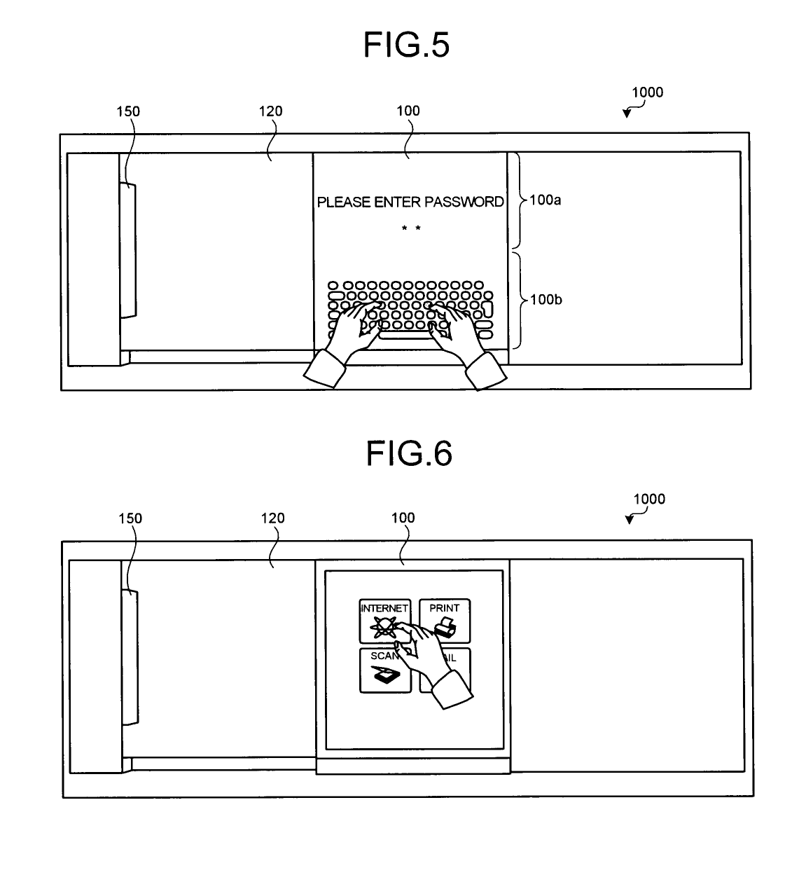

The liquid-crystal touch-panel monitor 100 is formed from a display, such as a liquid crystal display (LCD). FIG. 5 is a front view of the liquid-crystal touch-panel monitor 100. As shown in FIG. 5, the liquid-crystal touch-panel monitor 100 includes a display section 100a and a touch panel section 10b. The display section 100a is used to display a document, characters, an image, and the like. The touch panel section 100b is used by a user to input data or instructions.

More specifically, when the user operates a switch of the power supply unit 10 to turn on the printer 1000, as shown in FIG. 5, a message that prompts the user to enter a password appears on the display section 100a, and simultaneously a software keyboard appears on the touch panel section 100b. In response to the prompt, the user enters a password via the software keyboard on the touch panel section 100b.

Then, authentication of the user is performed by using the input password. If the user is confirmed to be an authentic user, a menu screen such as that shown in FIG. 6 is displayed on the liquid-crystal touch-panel monitor 100. Such a menu screen contains various icons each corresponding to a different operation. In the example shown in FIG. 6, the menu screen contains icons of “INTERNET”, “PRINT”, “SCAN”, and “EMAIL”. When the user touches an icon on the menu screen, an application software corresponding to the selected icon is executed.

Returning to FIG. 1, the output-unit bottom plate 110 made of iron or alloy such as steel alloy, and functions as a bottom surface of the box-shaped housing 200. The output-unit top plate 120 is made of a transparent material such as acrylic resin, glass, or the like, and functions as the top surface of the box-shaped housing 200. The output-unit bottom plate 110, the output-unit top plate 120, the paper output rollers 80, and the output-unit illuminating unit 150 are the components of the output unit D. A space is secured between the output-unit bottom plate 110 and the output-unit top plate 120. This space has openings at two locations: one on the side of the paper output rollers 80 and the other on the side of the user. The paper output rollers 80 eject an image-printed paper P into this space from the opening on the side of the paper output rollers 80. In other words, the paper output rollers 80 eject the image-printed paper P on the output-unit bottom plate 110. Because the output-unit top plate 120 is transparent, a user can check contents of a printout on the spot without moving. Moreover, the user can take out the image-printed paper P from the opening that is toward him.

The controller 140 controls operations of the units according to information entered by the user via the liquid-crystal touch-panel monitor 100. The controller 140 includes read only memory (ROM) and random access memory (RAM). The ROM stores therein various computer programs and data. For example, the ROM stores therein a computer program for controlling various units of the printer 1000, a computer program for performing non-contact detection of a security card to authenticate a user, a computer program for translating a scanned document from one language (English) to other language (Japanese), and the like. The controller 140 moves data from the ROM to the RAM to perform various processes as required.

The output-unit illuminating unit 150 illuminates the image-printed paper P in the output unit D. The user can switch on the output-unit illuminating unit 150 when the surrounding is dark so that the user can view or check contents of the image-printed paper P through the output-unit top plate 120 without taking out the paper P.

The geljet engine 160 controls operations of the line scan heads of the printer unit 70 and causes the line scan heads to eject ink drops of corresponding colors onto the paper P.

The imaging unit 170 converts image data stored in the storage unit 20, or image data obtained by scanning performed by the scanner unit 50, into color image data sets of Y, M, C, and K, thereby forming latent images. The imaging unit 170 then develops the latent images with toners of the corresponding colors, thereby forming toner images of each color.

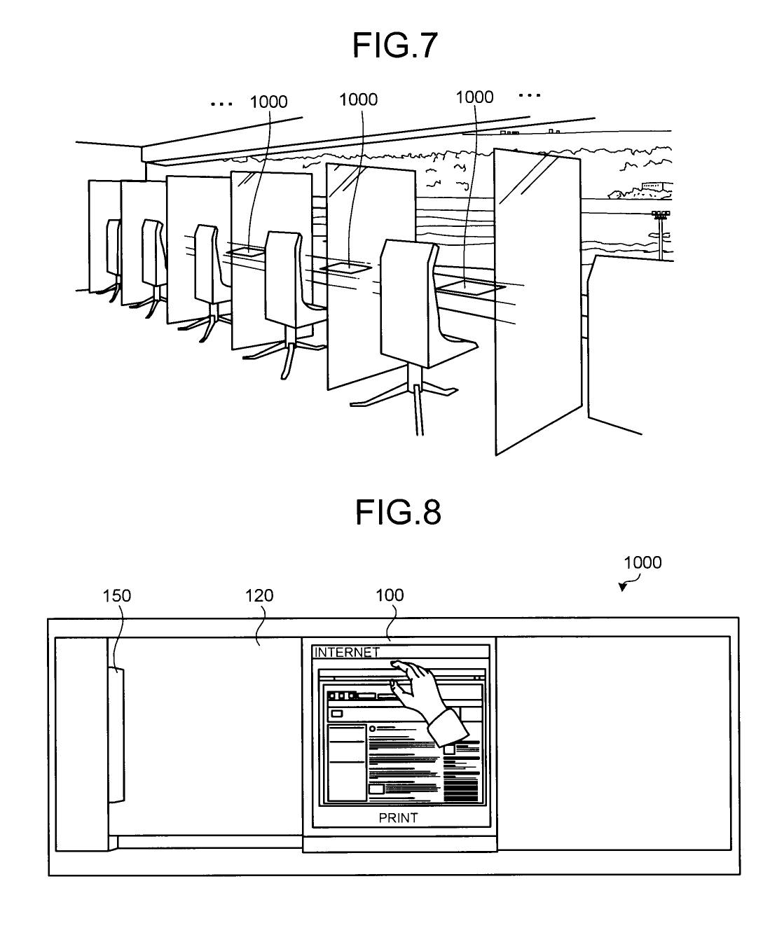

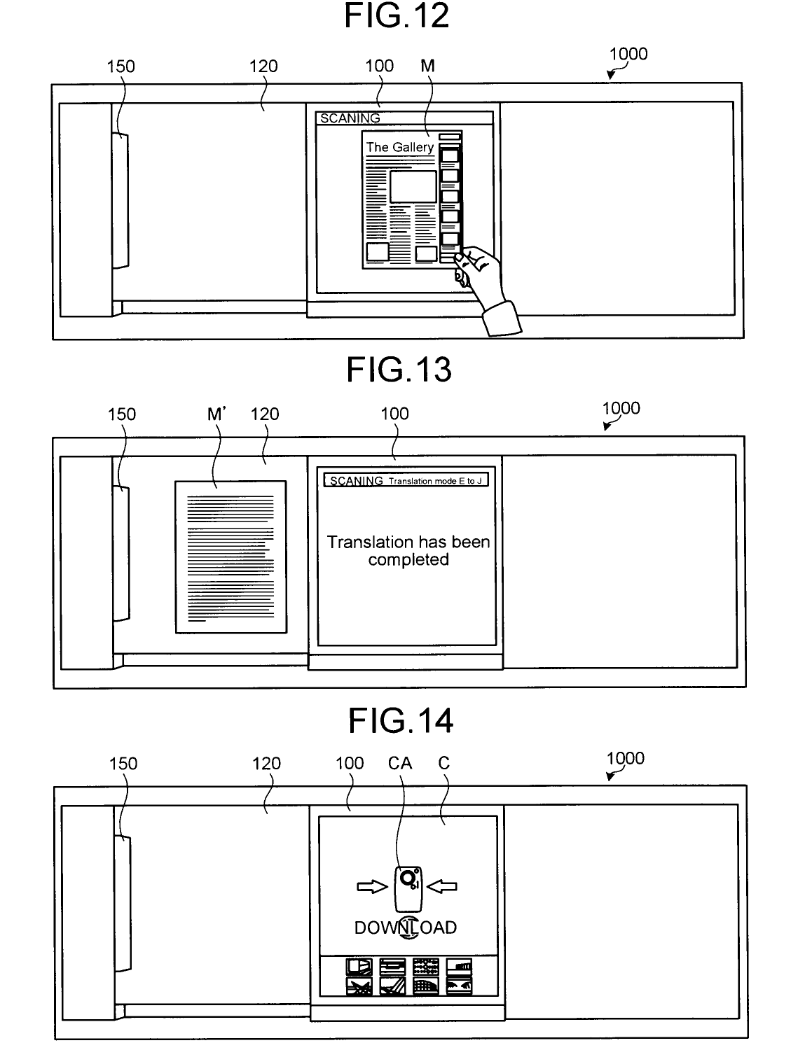

A specific example of application of the printer 1000 will be described with reference to FIGS. 7 to 17. In this example, it is assumed that a user, who is a product director and directing planning of a new product, uses the printer 1000 in making a presentation of the new product to a foreign customer.

FIG. 7 depicts inside of a lounge located inside a check-in gate of an airport, from which the user flies to the foreign customer. As shown in FIG. 7, a plurality of the printers 1000 is provided in the lounge for free use to lounge guests. Each lounge guest obtains a password at a reception of the lounge. When the guest enters the password from an authentication screen as shown in FIG. 5 and logs in, the menu screen of the printer 1000 shown in FIG. 6 appears. Meanwhile, a partition is provided between each adjacent pair of the printers 1000 to ensure security of a certain level for individual user.

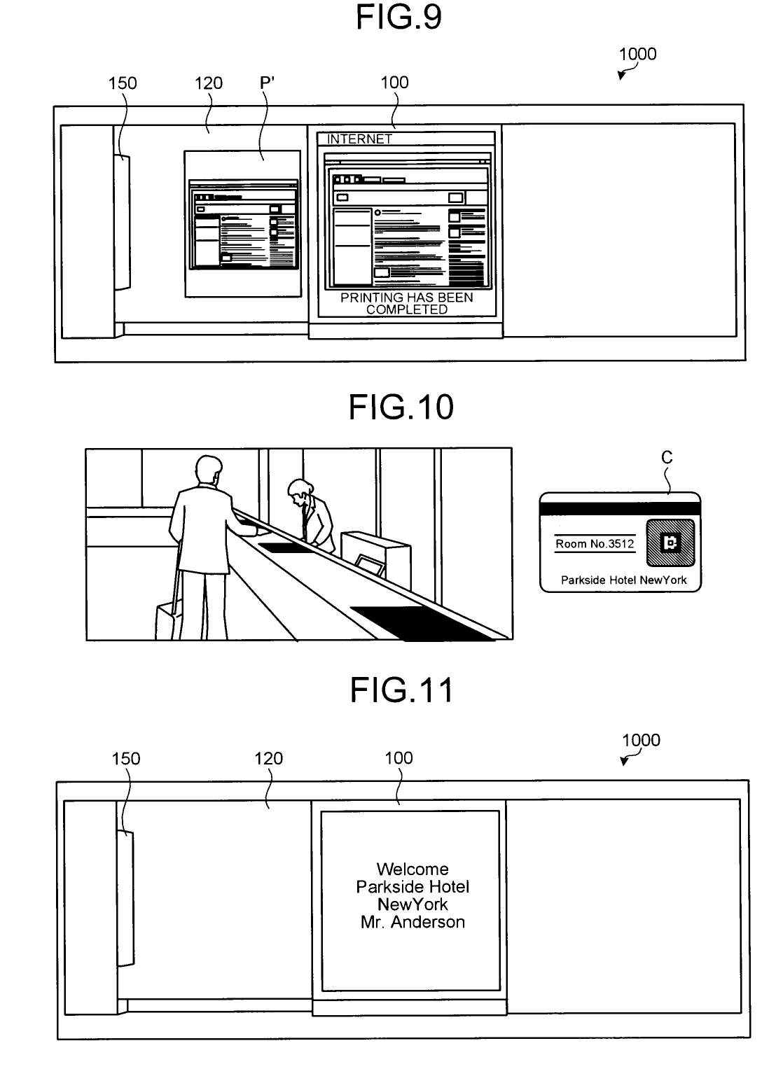

On viewing the menu screen, the user touches the liquid-crystal touch-panel monitor 100 to select icon “INTERNET”, and causes such a Web page as shown in FIG. 8 to appear on the liquid-crystal touch-panel monitor 100. After having caused a desired article or a content to be displayed, the user touches the liquid-crystal touch-panel monitor 100 to output the displayed screen on paper P′ into the output unit D as shown in FIG. 9. Thus, the user can check a printout of the screen displayed on the liquid-crystal touch-panel monitor 100 and take out the printout without moving nor changing the current posture.

After arriving at the destination country, the user checks in a hotel as shown in FIG. 10, and receives a security card C for use in entrance to a guest room, payment, and the like. The guest room, in which the user is to stay, has the printer 1000 similar to the printers 1000 provided in the airport lounge.

The user operates the switch of the power supply unit 10 to turn on the printer 1000, and holds the security card C near the liquid-crystal touch-panel monitor 100 of the printer 1000. The communication unit 40 communicates with the security card C and acquires information such as an authentication code, a secret identification code, and the like from the security card C and sends the acquired information to the controller 140. The controller 140 performs authentication of the user. If the controller 140 determines that the user is an authentic user of the printer 1000 of the guest room, the controller 140 displays a welcome screen as shown in FIG. 11. The controller 140 then displays the menu screen as shown in FIG. 6.

The user selects icon “SCANNER” from the menu screen displayed on the liquid-crystal touch-panel monitor 100, and places a magazine M on the liquid-crystal touch-panel monitor 100 as shown in FIG. 12. A page of the magazine M is scanned by the scanner unit 50, and contents of the scanned image are translated by the controller 140 into Japanese and then developed into toner images by the geljet engine 160. The printer unit 70 produces a printout of the toner images as paper M′, which is then ejected into the output unit D.

During these operations, the user can select icon “EMAIL” from the menu screen shown in FIG. 3 to access an email box of the user and perform a check of incoming e-mails or the like without moving from the current position.

The user holds a digital camera CA on the liquid-crystal touch-panel monitor 100 as shown in FIG. 14. The communication unit 40 of the printer 1000 establishes infrared communications with the digital camera CA, and downloads images stored in the digital camera CA to the storage unit 20. The controller 140 simultaneously displays the thus-stored images in a bottom section of the liquid-crystal touch-panel monitor 100 shown in FIG. 14.

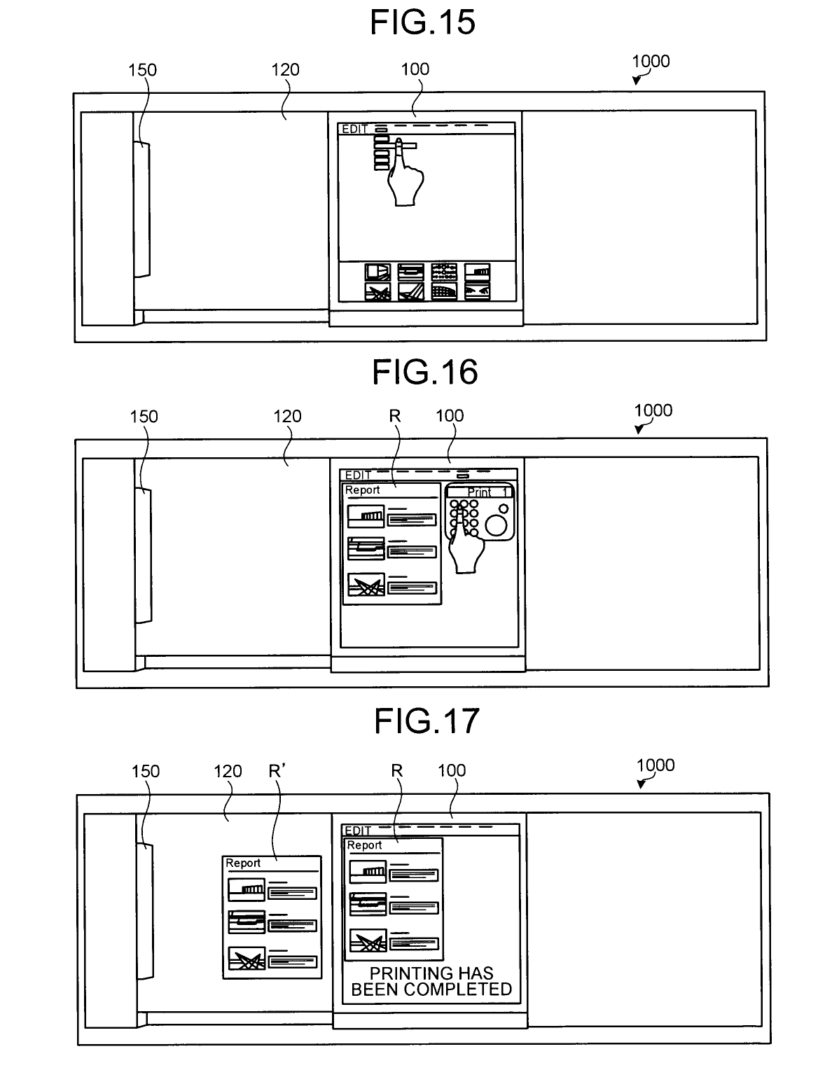

As shown in FIG. 15, the user interacts with the liquid-crystal touch-panel monitor 100 to in include the downloaded image data into predetermined report data.

As shown in FIG. 16, the user further interacts with the liquid-crystal touch-panel monitor 100 to set a print count of report data R that includes image data therein for the printer unit 70, and outputs a report document R′ into the output unit D. After checking contents of the report document R′ through the output-unit top plate 120, the user performs a presentation using the thus-prepared report document R′.

As described above, the printer 1000 includes the box-shaped housing 200 having the planar top surface, the legs 130, the paper feed unit 30 that houses paper therein, the imaging unit 170 that forms an image on the paper P, the output unit D that houses the image-printed paper P, and the paper-feeding rollers 60a to 60d that convey the paper P from the paper feed unit 30 to the output unit D. The paper feed unit 30, the imaging unit 170, the output unit D, and the paper-feeding rollers 60a to 60d are arranged inside the box-shaped housing 200 to be parallel to one another and to be parallel to the ground. This arrangement not only allows efficient use of space but also provides a user with improved operating efficiency and convenience.

In a conventional printer, the paper feed unit 30, the imaging unit 170, and the output unit D have been vertically stacked to minimize a footprint of the printer for efficient use of space. In contrast, according to the first embodiment, the paper feed unit 30, the imaging unit 170, and the output unit D are arranged parallel to one another and parallel to the ground so that the printer 1000 has a planer shape. This planar shape allows the printer 1000 to be used as a desk, thereby attaining efficient use of the space, which has conventionally been used only as the footprint of the printer. Furthermore, this configuration will not cause a user to have an impression of being oppressed. Conventionally, a user has performed a task that needs to be printed by editing the report data R or the like to be printed on a desk or the like, and producing a printout of the thus-edited data as the report document R′ or the like using a conventional printer of the vertically-stacked type. Accordingly, conventionally two spaces: one space for the desk or the like, on which the user prepares the document, and the other space for the printer that produces a printout of the prepared document have been required. In contrast, the printer 1000 allows a user to perform preparation and printing of a document in a location. Because the need of ensuring the two spaces: the one for the desk and the other for the printer, is eliminated, space can be utilized further efficiently.

Because the paper feed unit 30, the imaging unit 170, and the output unit D are positioned in coplanar relationship with one another, a paper feed path extends linearly. Hence, occurrence of jam, such as paper jam, is reduced.

The arrangement of the paper feed unit 30, the output unit D, and the scanner unit 50, and the like can be changed into a lateral mirror image thereof about the imaging unit 170, thereby increasing the degree of freedom in arrangement of these units.

Because the paper feed unit 30, the imaging unit 170, the output unit D, and the scanner unit 50 are provided as one unit in a center area of the box-shaped housing 200, maintainability is also improved. For instance, each unit can be easily replaced with the one having the latest specifications.

The printer 1000 also includes the liquid-crystal touch-panel monitor 100 as the top surface of the box-shaped housing 200. The liquid-crystal touch-panel monitor 100 displays various screens for the user to view and receives various data and commands from the user. Accordingly, space can be utilized efficiently and operating efficiency and convenience for a user are further improved.

According to the first embodiment, because the paper-feeding rollers 60a to 60d convey the paper P from the paper feed unit 30 to the output unit D generally along a horizontal plane so that the user can collect the image-printed paper P with moving from his seat. Hence, operating efficiency and convenience are further improved.

According to the first embodiment, the scanner unit 50 and the printer unit 70 are arranged parallel to each other. As a result, these units can be housed in a compact manner so that space can be utilized efficiently.

According to the first embodiment, because a scanning surface of the scanner unit 50 is faces above, scanning operation is facilitated, and hence operating efficiency and convenience are further improved.

According to the first embodiment, because the exposure glass doubles as a display screen of the liquid-crystal touch-panel monitor 100, these units can be housed more compact, and hence space can be utilized efficiently.

According to the first embodiment, because the printer 1000 includes the communication unit 40 that receives data from an external device by using wireless communications, data can be imported from the external device easily. Hence, operating efficiency and convenience are further improved.

According to the first embodiment, because the communication unit 40 is located near the display screen of the liquid-crystal touch-panel monitor 100, data can be imported to the printer 1000 easily only by bringing the external device near the display screen or into contact therewith. Hence, operating efficiency and convenience are further improved.

According to the first embodiment, because the top surface of the output unit D is transparent, a user can check a printout on the spot without moving from his current position. Hence, operating efficiency and convenience are further improved. Because the output unit D has an opening on the side of the user, the user can take out the paper P ejected into the paper output rollers 80 easily. Because the output-unit top plate 120 is transparent, the paper P is prevented from being unintentionally left in the output unit D. Because the opening is toward the user, i.e., front side, the printer 1000 can be installed laterally adjacent to a wall or the like, the printer 1000 can be located flexibly irrespective of an orientation thereof. Because the hollow is accessible from laterally either side, the user can make a presentation in a meeting or the like efficiently without turning back to other participants.

According to the first embodiment, because the printer 1000 further includes the paper detector 90 that detects the paper P ejected from the imaging unit 170 into the output unit D, the user is informed of completion of printing on the spot easily. Hence, operating efficiency and convenience are further improved.

In the first embodiment, the top surface of the box-shaped housing 200, or the liquid-crystal touch-panel monitor 100, is formed into a flat surface parallel with the horizontal so that the space below the box-shaped housing 200 can be efficiently used. Alternatively, a pivot can be provided in any one of a longitudinal edge line of the box-shaped housing 200 and that of the liquid-crystal touch-panel monitor 100 so that the corresponding one of the box-shaped housing 200 and the liquid-crystal touch-panel monitor 100 tilts an appropriate tilt angle (in the range of 5 degrees to 15 degrees, for example). When this alternative configuration is employed, the liquid-crystal touch-panel monitor 100 can be moved to have an easily-viewable angle, and hence convenience for a user is further improved.

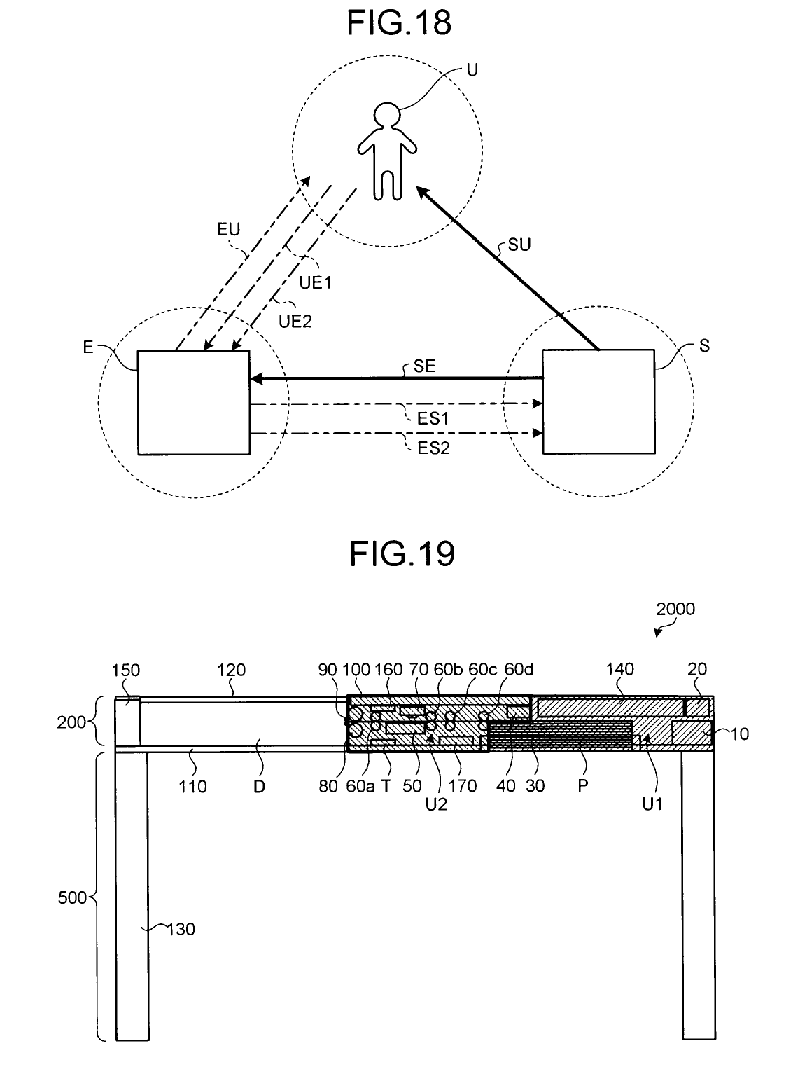

Subsequently, another example of application of the printer 1000 will be described. FIG. 18 is a schematic diagram for explaining a relationship among a provider S of the printer 1000, an enterprise E that provides a user with a service using the printer 1000, and typical users U.

The provider S is a company, a group, or the like that provides the printer 1000 to the enterprise E or the users U by manufacturing, selling, lease, or a like manner. FIG. 18 depicts an example case in which the provider S leases the printer 1000 to the enterprise E.

The enterprise E is a company or a group that runs a hotel chain, office rental business, a fast food chain, or the like, and capable of installing the printer 1000. The users U are general consumers each being free to receive the service provided by the enterprise E or use the printer 1000 provided by the provider S.

The enterprise E is provided with the printer 1000 from the provider S by lease (SE). For instance, when the enterprise E is a hotel chain, the enterprise E can install the printer 1000 in a guest room of a hotel of the chain, thereby providing the users U with space of greater comfort as a value-added service (EU).

Meanwhile, the provider S receives rental fees and charges for maintenance of the printer 1000 from the enterprise E (ES1). The provider S is also informed of usage conditions of the printer 1000 used by the users U and statistical data about customer satisfaction and the like from the enterprise E (ES2), thereby keeping track of customers' needs.

The enterprise E provides the users U with the value-added space as described above, thereby being paid for usage charges appropriate to the space (EU1). In addition, the enterprise E can acquire additional customers through word-of-word communication among the users U and the like (EU2).

The provider S can provide the printer 1000 to the enterprise E, inform the users U about the printer 1000, and run advertisements of the printer 1000, thereby appealing the brand value of the provider S as a company or a group that produces or sells the printer 1000, with which a value-added space can be provided, and increasing the brand-name recognition (SU).

As described above, the provider S can expect, in addition to rental fees, increases of the brand name and brand-name recognition. The enterprise E can expect enhancement of an image of the enterprise E, acquisition of additional customers, and usage charges in return for provision of the value-added space. The users U can receive more convenient service. Hence, the printer 1000 is extremely valuable for each of the provider S, the enterprise E, and the users U.

In the first embodiment, the printer 1000 includes the box-shaped housing 200 having the planar top surface and the other units; and the paper feed unit 30, the imaging unit 170, and the output unit D are provided inside the box-shaped housing 200 and arranged parallel to one another so that space can be utilized efficiently. However, an increase in variety of users' needs can require the printer to be customized to satisfy each of the users' needs and provided in various versions. Examples of such a version include printers of which units, such as a paper feed unit and an imaging unit, are customized independently. A second embodiment of the present invention that enables customization of a printer 2000 by replacement of a corresponding unit(s) or a like method, thereby avoiding customization of the entire printer 2000 and providing the printer 2000 in various versions, will be described below.

FIG. 19 depicts a physical configuration of the printer 2000. The printer 2000 shown in FIG. 19 has almost the same configuration as the printer 1000. However, the printer 2000 differs from the printer 1000 in that the paper feed unit, the imaging unit, and the like units are integrated into one unit assembly. FIG. 19 depicts an example in which the controller 140, the paper feed unit 30, the storage unit 20, and the power supply unit 10 are integrated into a unit assembly u1, and the imaging unit 170, the scanner unit 50, the printer unit 70, and the like units are integrated into another unit assembly u2.

It is assumed that the printer 2000 includes only the unit assemblies u1 and u2; however, the printer 2000 can include other unit assemblies. For instance, each of the units can be formed as a separate unit assembly. In the following descriptions, the output unit D is assumed to be fixed. However, as a matter of course, the output unit D can be detachably placed on a frame FR, which will be described later, in a manner similar to the unit assemblies u1 and u2. The second embodiment is described by adopting the unit assembly u1 as an example of the first housing in the appended claims, the unit assembly u2 as an example of the second housing, and a unit assembly including the output unit D as an example of the third housing. The units included in each unit assembly (e.g., the controller 140 and the paper feed unit 30 included in the unit assembly u1) are not necessarily fixed. For instance, the controller 140 can be included in the unit assembly u2. FIG. 20 is an external perspective view of the printer shown in FIG. 19. As shown in FIG. 20, the unit assemblies u1 and u2 are detachably provided in the printer to extend perpendicularly to the legs 130 of the printer 2000 (i.e., parallel to the horizontal). A structure of mounting the unit assemblies to the printer will be described below.

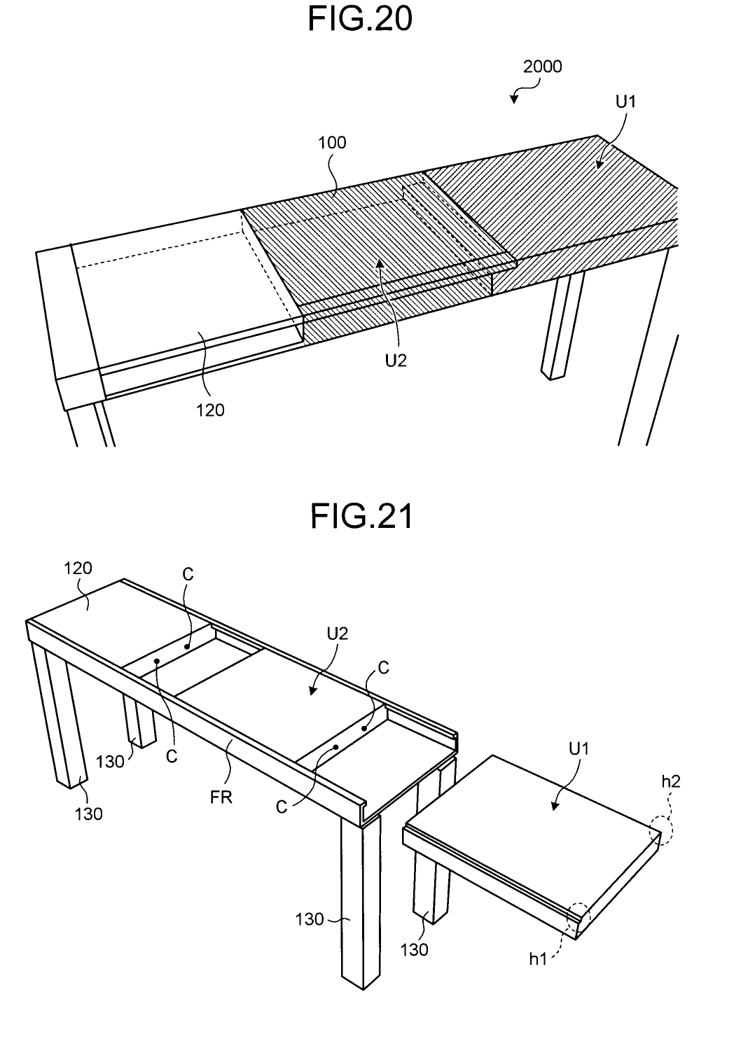

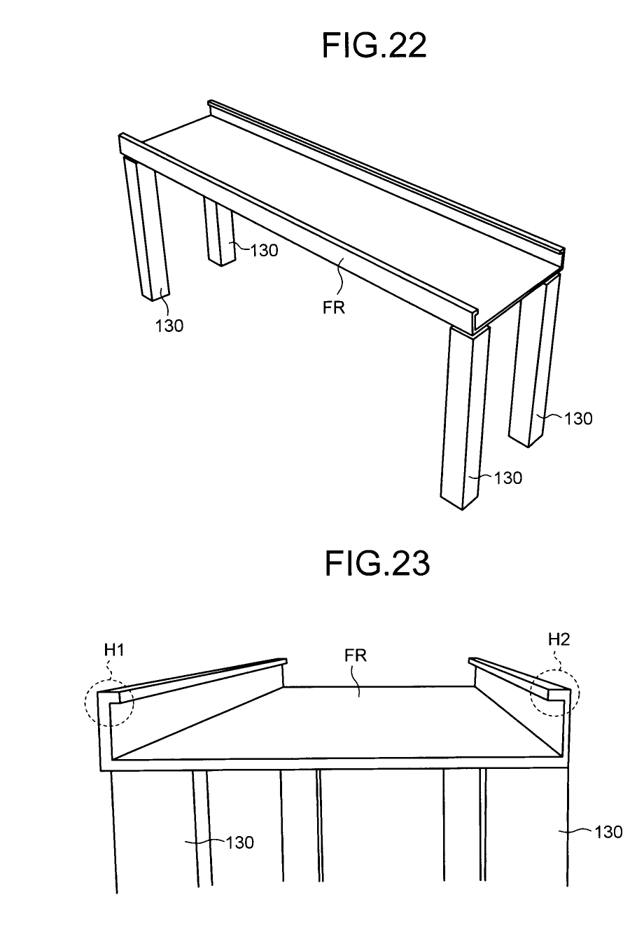

FIG. 21 depicts a relation among the unit assemblies u1 and u2 and the frame FR, which is a component of the printer 2000. As shown in FIG. 21, the frame FR surrounds the unit assemblies u1 and u2 from bottom surfaces and side surfaces of the unit assemblies, except for top surfaces, and has protrusions H1 and H2 on end portions of the frame FR. Meanwhile, the unit assemblies u1 and u2 have recesses h1 and h2 that receive the protrusions H1 and H2, which will be described later, on the frame FR are to be fitted thereinto, respectively, for sliding motion of the unit assemblies u1 and u2 along the horizontal surface of the frame FR.

Put another way, each of the unit assemblies u1 and u2 is horizontally movable in a longitudinal direction of the frame FR to be attached to and detached from the frame FR. When, for instance, the controller 140 included in the unit assembly u1 is to undergo customization or the like at a request of a user or for repair or the like, the unit assembly u1 is removed by sliding the unit assembly u1 in the longitudinal direction of the frame FR, and a unit assembly u3 (not shown) is attached to the frame FR as a substitute of the unit assembly u1. Accordingly, provision of the service, which has been provided to the user until the replacement, is continued without being suspended.

Hence, when a printer is constructed as described above to allow replacement of each of the unit assemblies, a user is protected from being interfered with operations even when one of the units of the printer requires maintenance. Integrating the units into the unit assemblies facilitates selection of functions, such as copying and scanning, of the printer, thereby making it possible to satisfy the users' needs flexibly.

As shown in FIG. 21, connectors C are provided on the unit assemblies u1 and u2 so that the unit assemblies u1 and u2 can be detachably connected to each other by connecting the connectors C together. Accordingly, for instance, another unit assembly u3 (which is, for instance, a unit of a version different from the unit assemblies u1 and u2) can be combined with the unit assembly u1 or u2 to construct another printer. Hence, a printer that meets a user's needs can be provided easily.

FIG. 22 is a perspective view of the frame FR of the printer 2000 shown in FIG. 21. FIG. 23 depicts an end portion of the frame FR shown in FIG. 22 as viewed along the longitudinal direction of the frame FR. As shown in FIG. 22, the frame FR has, in longitudinal opposite ends of the frame FR, openings through which each of the unit assemblies u1 and u2 can be detachably attached to the frame FR.

In the second embodiment, the openings are provided in the longitudinal ends of the frame FR. Alternatively, openings can be defined on sides other than the longitudinal ends (i.e., in side portions on which the projections H1 and H2 shown in FIG. 23 are formed) of the frame FR. According to this alternative configuration, the distance over which each of the unit assemblies u1 and u2 is horizontally moved on the frame FR decreases. Hence, attachment and detachment of the unit assemblies u1 and u2 is facilitated.

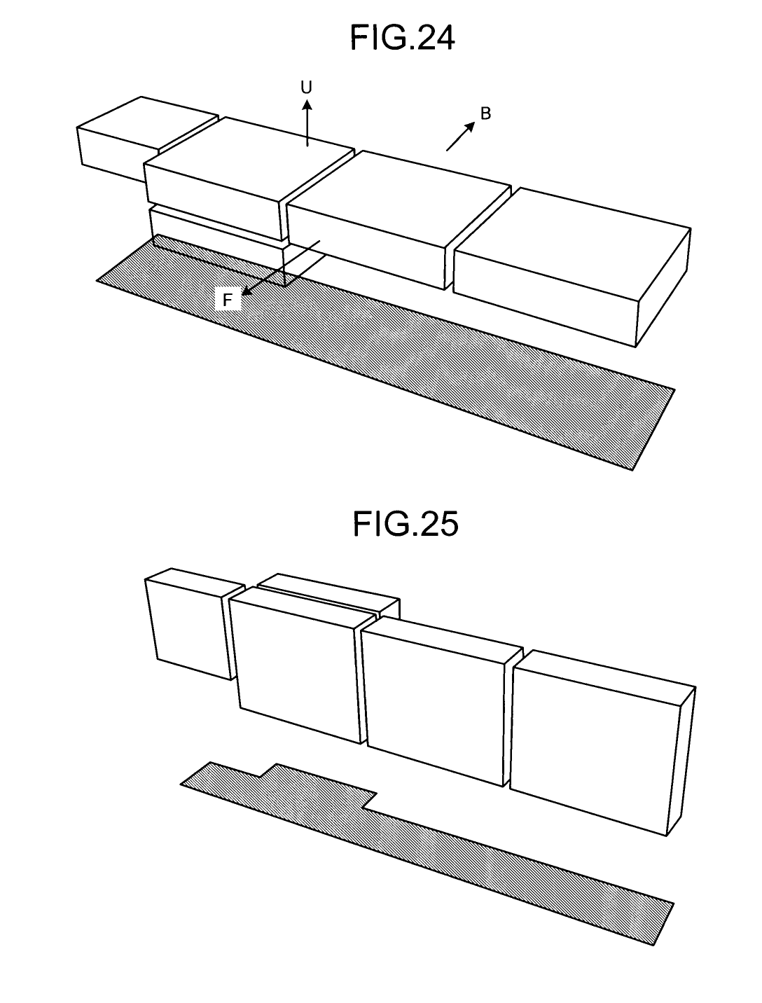

FIG. 24 depicts only unit assemblies of the printer 2000 that includes such unit assemblies as described above. As shown in FIG. 24, the unit assemblies of the printer 2000 are horizontally arranged along the longitudinal direction of the printer 2000, and hence users can use space efficiently. For instance, users can have a face-to-face meeting by taking seats on at least one of a front side (F) and a back side (B) of the printer 2000.

The horizontal arrangement of the unit assemblies allows heat produced by operation of each unit assembly to be released efficiently through a bottom of the unit assembly. Because the legs 130 extend from the longitudinal ends of the frame FR, the height of the printer 2000 can be aligned with other office fixtures (e.g., an office desk or a table for meeting) by adjusting the length of the legs 130, thereby further improving operability.

FIG. 24 depicts an example configuration of the printer 2000, in which each of the unit assemblies u1, u2, and the other unit assemblies is detachably installed. Alternatively, the unit assemblies can be arranged such that the top surfaces of the unit assemblies of the printer 2000 form a shape other than a rectangle; e.g., a shape resembling a U-shaped desk. To implement this alternative configuration, it is also necessary to construct the frame FR to have the shape other than the rectangle (e.g., the U-shape).

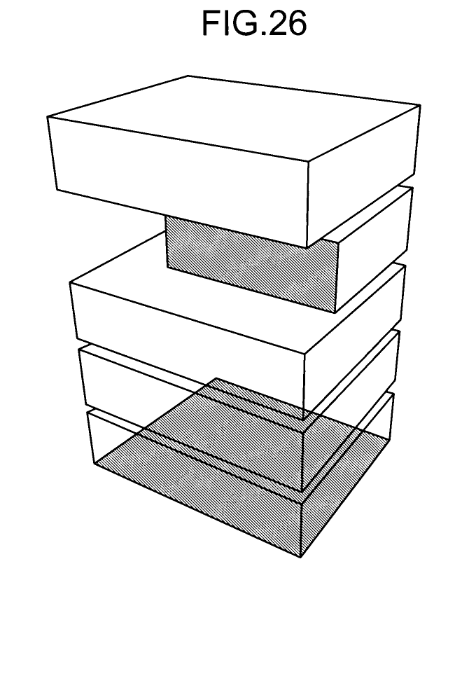

FIG. 25 depicts an example arrangement of the printer 2000 installed in a vertical orientation. Because the unit assemblies of the printer 2000 are supported by the projections H1 and H2 of the frame FR as shown in FIGS. 21 to 23, even when the printer 2000 is in the vertical orientation as shown in FIG. 25, the unit assemblies are prevented from being released and dropped from the frame FR. Hence, when the printer 2000 is placed near a wall or a window of a room in this orientation, space can be utilized further efficiently.

That is, the printer according to the second embodiment includes the horizontal frame FR, to which the unit assemblies can be detachably attached. The frame FR has the projections for causing each unit assembly to be fit into the frame, and each unit assembly includes the recess. Meanwhile, the recess can be defined in the frame and the projection can be provided in each unit assembly. Accordingly, even when the printer is in a stand-up orientation perpendicular to the horizontal or hung on a wall, each unit assembly is prevented from being released and dropped from the frame. Hence, space can be utilized more efficiently.

The unit assemblies have the connectors for detachable attachment therebetween. By connecting the connectors provided in each of the unit assemblies, the unit assemblies are installed such that the top surfaces of the unit assemblies form a generally horizontal, flat surface. When the unit assemblies are installed such that the top surfaces thereof extend generally horizontally, the top surfaces of the unit assemblies can be utilized as a working space, thereby allowing efficient use of space.

The generally horizontal arrangement of the unit assemblies improves convenience for users in various manners. In the conventional printers, each unit assembly is installed in a vertical orientation on the premise that operations for copying and other functions are performed in a standing position. Accordingly, for instance, for a user on a wheelchair it could be difficult to operate a control panel of the printer, or taking out an ejected paper. When the unit assemblies are horizontally arranged, a user can advance a wheelchair under the unit assemblies, and operate the control panel and the like from a nearer position. Hence, convenience is improved also for users on wheelchairs.

As described above, the printer 2000 allows more efficient use of space than the conventional printer as shown in FIG. 26 in which the unit assemblies are vertically stacked, and is capable of providing a printer that satisfies users' needs easily.

According to the present invention, space can be utilized efficiently, and operating efficiency and convenience for a user are improved.

According to the present invention, a user is not required to move, and hence operating efficiency and convenience are further improved.

According to the present invention, the printer unit and the scanner unit are housed compact, and hence space can be utilized efficiently.

According to the present invention, scanning operation is facilitated, and hence operating efficiency and convenience are further improved.

According to the present invention, the original reading surface and the operation display unit are housed compact, and hence space can be utilized further efficiently.

According to the present invention, data can be imported from an external device easily, and hence operating efficiency and convenience are further improved.

According to the present invention, data can be imported more easily only by bringing an external device near the display screen or into contact therewith, and hence operating efficiency and convenience are further improved.

According to the present invention, a user can check a printout on the spot without moving from the current position, and hence operating efficiency and convenience are further improved.

According to the present invention, a user is informed of completion of printing on the spot easily, and hence operating efficiency and convenience are further improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a housing having a substantially planar top surface;
a plurality of legs projecting downward from the housing for supporting the housing on ground;
a paper feed unit that houses a blank paper therein;
an image forming unit that performs image forming operation on a blank paper to obtain an image-printed paper;
an output unit that receives the image-printed paper from the output unit; and
a conveying unit that conveys the blank paper from the paper feed unit to the image forming unit and conveys the image-printed paper from the image forming unit to the output unit, wherein
the paper feed unit, the image forming unit, and the output unit are arranged in a substantially horizontal direction inside the housing.

2. The image forming apparatus according to claim 1, further comprising an operation display unit arranged on the top surface of the housing, the operation display unit capable of displaying data for a user and receiving input of data from the user.

3. The image forming apparatus according to claim 1, wherein the conveying unit conveys the blank paper from the paper feed unit to the image forming unit and conveys the image-printed paper from the image forming unit to the output unit in a substantially horizontal direction.

4. The image forming apparatus according to claim 1, further comprising a scanner unit that scans a surface of a printed material and a printer unit that performs printing on the blank paper based on the image forming operation performed by the image forming unit, wherein
the scanner unit and the printer unit are arranged in a substantially horizontal direction inside the housing.

5. The image forming apparatus according to claim 1, wherein the scanner unit has a scanning surface on the top surface of the housing.

6. The image forming apparatus according to claim 1, wherein the scanning surface doubles as a display screen of the operation display unit.

7. The image forming apparatus according to claim 1, further comprising a communication unit arranged inside the housing and capable of performing wireless communications with an external device.

8. The image forming apparatus according to claim 7, wherein the communication unit is provided near the display screen of the operation display unit.

9. The image forming apparatus according to claim 1, wherein a portion of the top surface of the housing that is above the output unit is made from transparent material.

10. The image forming apparatus according to claim 1, further comprising a detector that detects whether the image-printed paper is ejected in the output unit from the image forming unit.

11. A method to be performed by an image forming apparatus, the image forming apparatus including
a housing having a planar top surface;
a plurality of legs projecting downward from end portions of the housing for supporting the housing on ground;
a paper feed unit that houses a blank paper therein;
an image forming unit that performs image forming operation on a blank paper to obtain an image-printed paper;
an output unit that receives the image-printed paper from the output unit; and
a conveying unit that conveys the blank paper from the paper feed unit to the image forming unit and conveys the image-printed paper from the image forming unit to the output unit, wherein
the paper feed unit, the image forming unit, and the output unit are arranged in a substantially horizontal direction inside the housing, the method comprising:
the conveying unit conveying a blank paper from the paper feed unit to the image forming unit;
the image forming unit performing image forming operation on the blank paper to obtain an image-printed paper; and
the conveying unit conveying the image-printed paper from the image forming unit to the output unit.

12. An image forming apparatus comprising:
a paper feed unit that houses a blank paper therein;
a scanner unit that scans a surface of a printed material to obtain image data of the surface;
an image forming unit that performs image forming operation on a blank paper based on the image data to obtain an image-printed paper;
an output unit that receives the image-printed paper from the output unit;
a first housing having a planar top surface and housing the paper feed unit;
a second housing having a planar top surface and housing the scanner unit and the image forming unit;
a third housing having a planar top surface and housing the output unit;
a frame detachably supporting the first housing, the second housing, and the third housing; and
a plurality of legs projecting downward from end portions of the frame for supporting the frame on ground, wherein
the frame supports the first housing, the second housing, and the third housing in a substantially horizontal direction.

13. The image forming apparatus according to claim 12, wherein each of the first housing, the second housing, and the third housing has a connector unit for connecting with other housing.

14. The image forming apparatus according to claim 12, wherein the frame supports the first housing, the second housing, and the third housing such that top surfaces of the first housing, the second housing, and the third housing form a generally horizontal surface with no step.

15. The image forming apparatus according to claim 12, wherein the frame externally surrounds the first housing, the second housing, and the third housing except for the top surfaces of the first housing, the second housing, and the third housing, and has a projection on an end portion of an outer periphery of the frame.

16. The image forming apparatus according to claim 12, wherein each of the first housing, the second housing, and the third housing has a recess into which the projection formed on the frame is to be fitted.

17. The image forming apparatus according to claim 12, wherein frame supports the second housing in between the first housing and the third housing.
